(19) United States
(12) Patent Application Publication
(10) Pub. No.: US 2005/0246692 A1
(43) Pub. Date: Nov. 3, 2005

(54) Asynchronous compilation

(75) Inventors: Viktor Poteryakhin, Plymouth, MN (US); Michael V. Opletayev, Plymouth, MN (US)

Correspondence Address: Schwegman, Lundberg,;Woessner & Kluth, P.A., P.O. Box 2938, Minneapolis, MN, 55402, US

(73) Assignee: Convey Development, Inc.

(21) Appl. No.: 11/106,854

(22) Filed: Apr. 15, 2005

Related U.S. Application Data
(60) Provisional application No. 60/566,051, filed on Apr. 28, 2004.

(51) Int. Cl. G06F 9/45

(52) U.S. Cl. 717/140

(57) ABSTRACT

An asynchronous compiler uses language constructs to mark methods as asynchronous. For every asynchronous method call the compiler generates a re-entry point right before the next operator and a call back for the generated re-entry point. The asynchronous compiler may also enable structured error handling (SEH) by directing error notifications to appropriate catch statements in try-except blocks. The asynchronous compiler hides the awkward complexity of APM from the programmer, allowing him or her to focus on the logical function of the application.

### RELATED APPLICATION

This application claims priority to U. S. Provisional application Ser. No. 60/566,051 (entitled Asynchronous Compilation, filed Apr. 28, 2004) which is incorporated herein by reference.

### BACKGROUND

The Asynchronous Programming Model (APM) is becoming more and more widespread across modem execution environments. The high latency of executing methods bound to I/O operations makes it beneficial to split the execution of these operations into two parts. The first part accepts all required parameters, initiates processing and returns control before the actual I/O operation is complete. The second part is called when operation either finishes successfully or produces an error condition. This second part is usually invoked via a provided callback notification function or by sending the completion status to some queue. The idea is that between initiating a call and receiving completion notification the execution environment will use system resources to service other pending tasks.

A major driving force for APM in applications is the internet, where latency in accessing data is well above local area network scenarios. Another area where APM is highly beneficial is application servers handling very high numbers of simultaneous clients. Performance of traditional single user context per thread/process model degrades dramatically at high loads.

Coding complexity prevents APM from mainstream acceptance in both of these application classes. The predominant APM programming pattern is to code notification methods that are called on successful or unsuccessful completion of an initial method. The notification methods resynchronize execution flow broken by initial asynchronous call. When execution involves calling several methods controlled with logical conditions and/or iteration loops, relatively simple tasks result in rather complex source code. Most non-trivial applications become extremely complex to develop and hard to maintain.

### SUMMARY

An asynchronous complier derives asynchronous programming model (APM) code from straightforward source code. The asynchronous compiler hides the awkward complexity of APM from the programmer, allowing him or her to focus on the logical function of the application.

An asynchronous compiler uses language constructs to mark methods as asynchronous. For every asynchronous method call the compiler generates a re-entry point right before the next operator and a call back for the generated re-entry point. The asynchronous compiler may also enable structured error handling (SEH) by directing error notifications to appropriate catch statements in try-except blocks.

### BRIEF DESCRIPTION OF THE DRAWINGS

FIG. 1 is a flow chart of an execution thread for a simple logic flow according to an example embodiment.

FIG. 2 is a flow chart showing execution flow for asynchronous execution of the simple logic flow of FIG. 1 according to an example embodiment.

FIG. 3 is an example of source code calling two external service methods for compilation by an asynchronous compiler according to an example embodiment.

FIGS. 4A and 4B are an example of the functionality expressed in low level code similar to the functionality produced by the compilation of the example source code of FIG. 3.

FIG. 5 is a flowchart illustrating operation of an asynchronous complier according to an example embodiment.

FIGS. 6A and 6B show example source code similar in function to the source code of FIG. 3 written in an alternative language according to an example embodiment.

FIG. 7 is example source code similar in function to the source code of FIG. 3 written in yet a further alternative language according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

An asynchronous programming model (APM) is discussed with reference to a simple logic flow, and the resulting asynchronous call execution flow. Source code for an example having two calls to asynchronous resources is then described, with the resulting functionality when compiled. Functions performed by a complier are then described, followed by further alternative language source code examples.

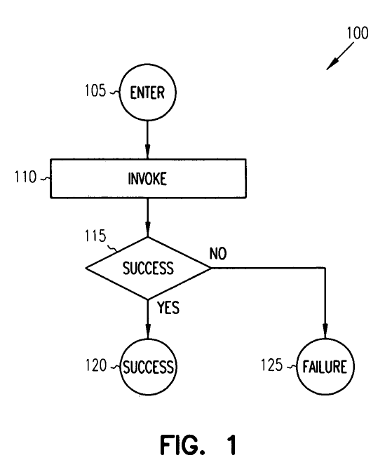

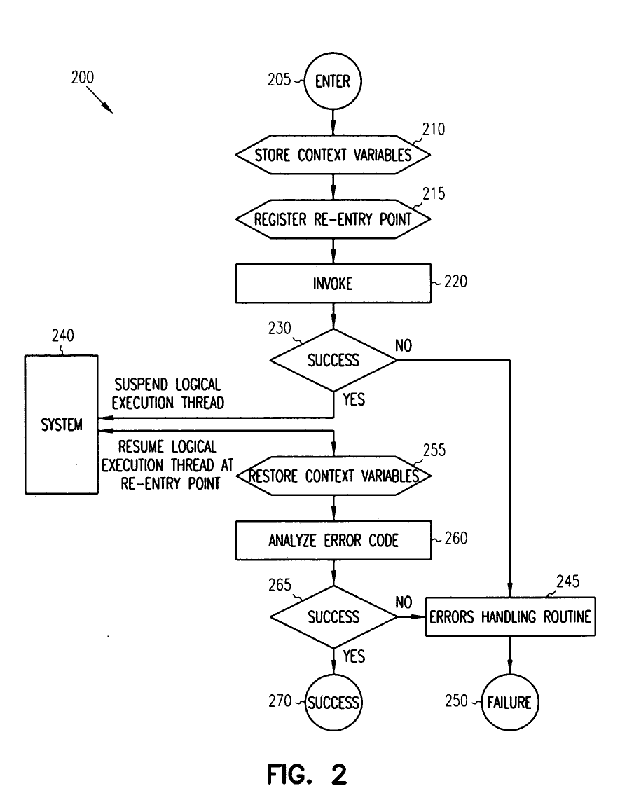

The difference between asynchronous compilation (AC) and conventional APM implementation is illustrated by a simple program 100 example in FIGS. 1 and 2. A simple method call is illustrated. The program 100 is entered at 105, and a method call is invoked at 110. Decision block 115 determines whether the method call was successful at 120 or a failure at 125.

FIG. 2, at 200 shows the actual execution flow of a thread following compilation of program 100 by an asynchronous compiler in accordance with an example embodiment of the present invention. At 205, the program is entered. At 210, context variables are stored. At 215, a register re-entry point is determined, and the method of invoked at 220. At 230, if the method is successfully invoked, logical execution of the thread is suspended, and the method is executed by system 240. If the method was not successfully invoked, an error handling routing 245 is entered, and failure of the program is noted at 250.

Following successful execution of the method at 240, logical execution of the thread is resumed at the re-entry point, and context variables are restored at 255. Error codes, if any, are analyzed at 260. If the success is determined at 265, the program is ended at 270. If the error codes indicate failure at 265, error handling routine 245 is entered at failure results at 250.

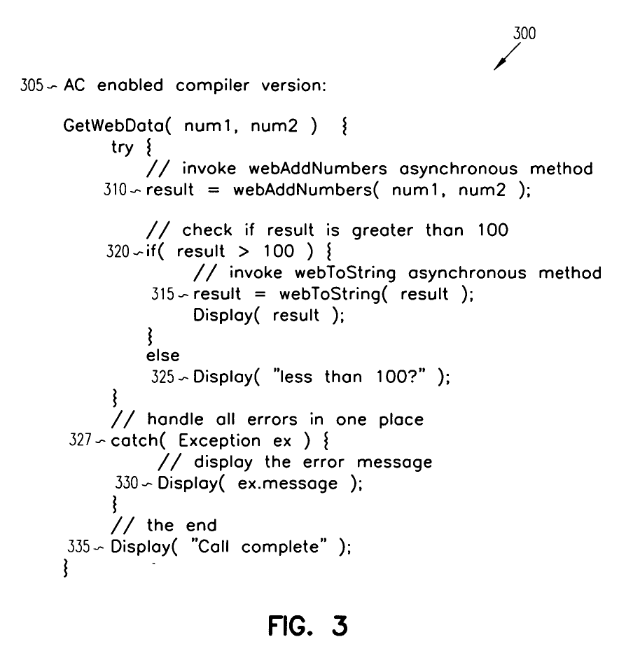

FIG. 3 is an example of source code routine 300 calling two external service methods for compilation by an asynchronous compiler according to an example embodiment. The routine 300 will try to call two external web service methods. webAddNumbers ( ), called at 310, returns the sum of its 2 number arguments. webToString( ), called at 315, if the result of the first call was less than 100 at 320, returns the string value of its number argument.

The routine 300 proceeds as follows. Routine 300 first accepts two numbers at 305, and then calls an asynchronous method, webAddNumbers at 310. If the result is greater than 100 at 320, routine 300 calls webToString at 315 using the result as the argument, otherwise it sets answer string to a constant value, “less than 100 . . . ” at 325. Errors are handled at 327. If no error occurs the answer string is then displayed, otherwise the error message is displayed at 330. Finally “Call complete” is displayed at 335. In this example the asynchronous compiler only needs to know that the methods are asynchronous. In one embodiment, an “asynchronous method” attribute is set to true for webAddNumbers and webToString methods. The programmer may not even realize that code will be run by an APM enabled engine. This is the conventional way of writing programs. The compiler has all the information needed to produce the low level code functionally.

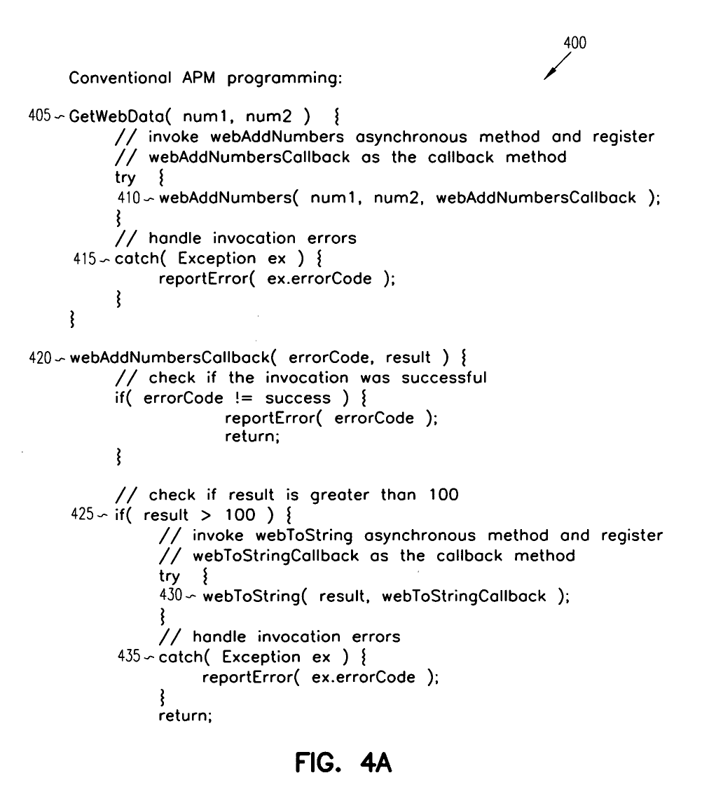

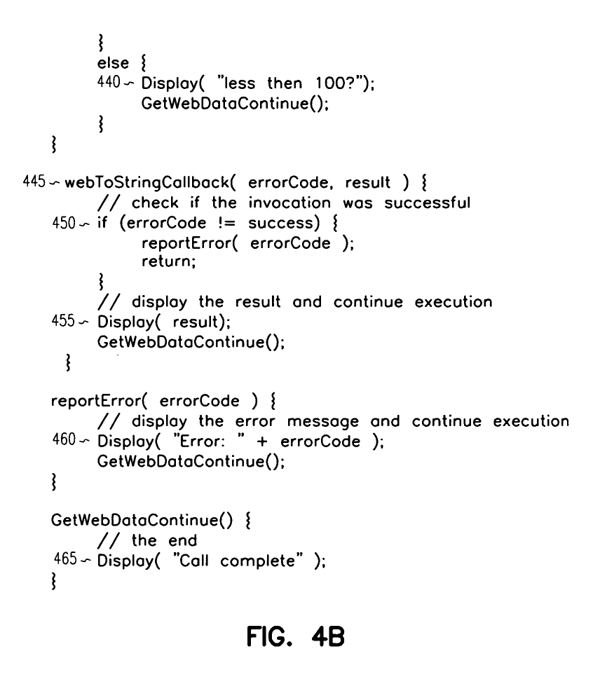

FIGS. 4A and 4B are an example of the functionality of the routine 300 expressed in APM low level code indicated generally at 400. Code 400 first accepts two numbers at 405, and then calls the asynchronous method, webAddNumbers at 410. This call has a callback (webAddNumbersCallback) set as the re-entry point Invocation errors are handled at 415 and reported.

The re-entry point for webAddNumbersCallback is provided at 420, and processing errors are handled. At 425, if the result is greater than 100, a second asynchronous method, webToString is called at 430, with a callback (webToStringCallback). Invocation errors are caught and reported at 435. If the result was less than 100, a string is displayed at 440. The callback re-entry point for webToStringCallback is provided at 445. Processing errors are handled again at 450. The result is displayed at 455, and further error reporting may occur at 460. Code 400 ends with a display of “Call complete” at 465.

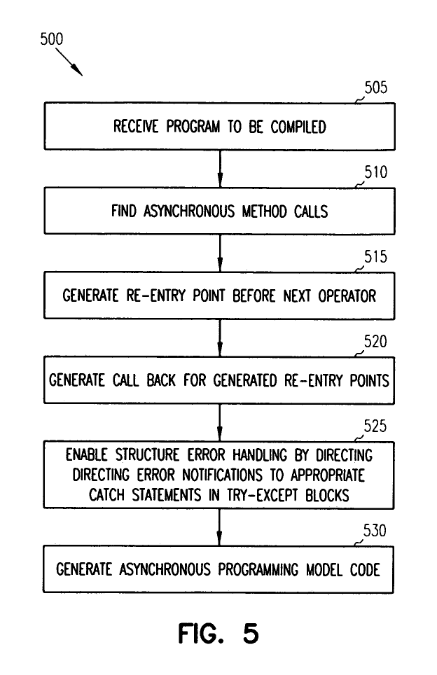

FIG. 5 is a flowchart illustrating operation of an asynchronous complier 500 according to an example embodiment. Only aspects of the compiler relating to APM asynchronous calls are illustrated to simplify the explanation. It is understood that other compiler functions may also be performed by the asynchronous compiler, such as optimizations, parsing and other functions as needed.

A program to be compiled is received at 505. The asynchronous method calls are found at 510. Re-entry points are generated prior to a next operator at 515, and callbacks for the re-entry points are generated at 520. Structured error handling may be enabled by directing error notifications to appropriate “Catch” statements in Try-Except blocks at 525. AMP code is then generated at 530 with the callbacks and re-entry points. Structured error handling may also be embedded in such code.

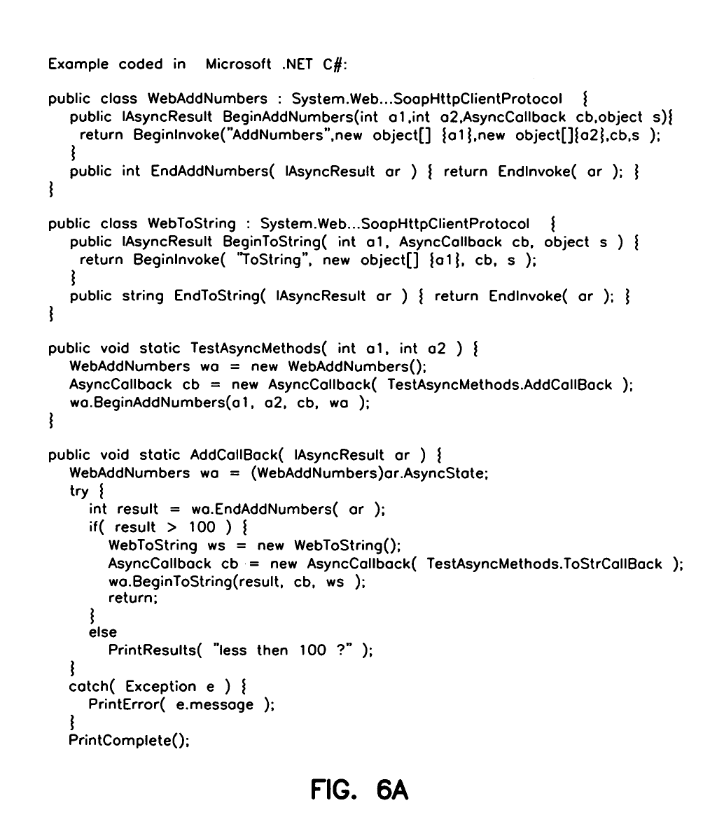

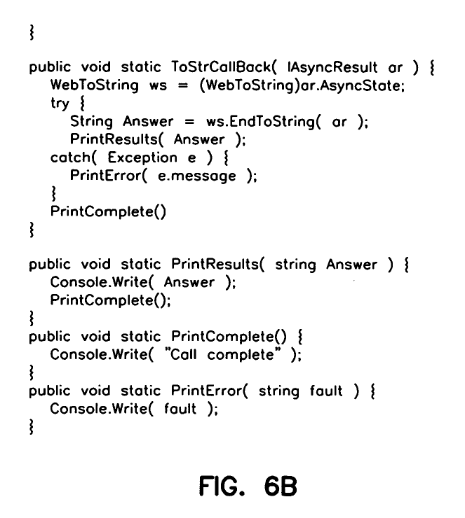

FIGS. 6A and 6B show example source code similar in function to the source code of FIG. 3 written in Microsoft NET C#.

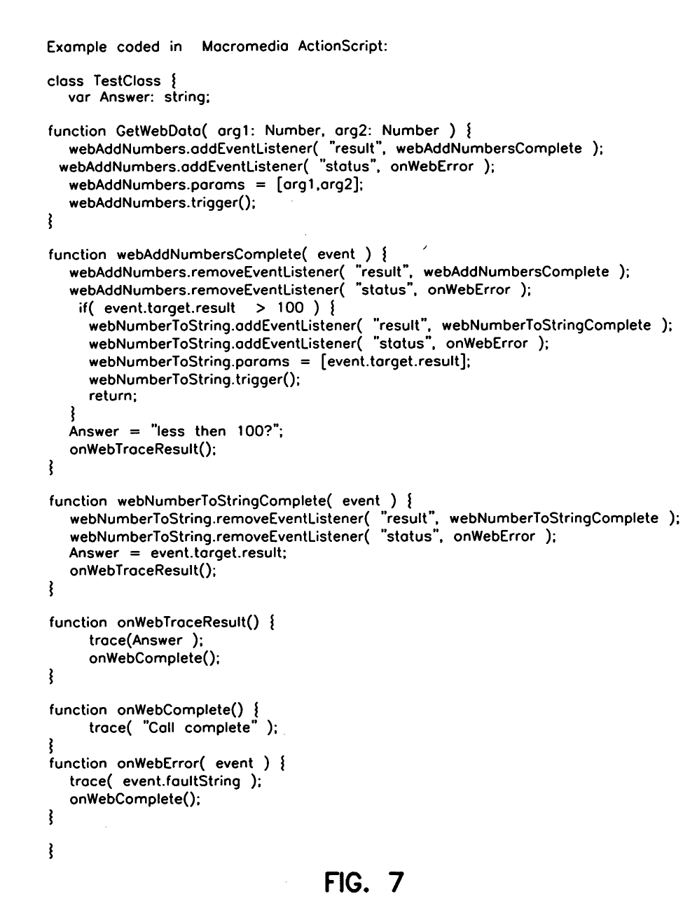

FIG. 7 is example source code similar in function to the source code of FIG. 3 written in Macromedia ActionScript.

While some existing languages provide direct support for parts of APM, it is provided explicitly in the syntax of the language. The programmer still needs to explicitly resynchronize the asynchronous processes as required by the application. The asynchronous compiler described herein can hide these tasks from the programmer and thus greatly simplify programming in the APM.

In one embodiment, the asynchronous compiler works on programs for running in an execution environment where local variables are maintained in memory as opposed to references to the processor execution stack. In such embodiments, when a call of an asynchronous method or sub-routine occurs in the source code, the compiler generates a re-entry point before the next operator that immediately follows the call. Code is generated to register the re-entry point as a notification method for the call with the execution environment. A call initiating the asynchronous operation with reference to the notification method is generated and a return of control from the current routing to the execution environment is also generated. Code to raise an exception to the execution environment if any errors occur may also be generated.

In a further embodiment, the asynchronous compiler works on programs for running in an execution environment where local variables are realized as references to the processor execution stack. In such embodiments, code is generated to persist the calling method's local variables, and a callback method is generated that restores the local variables from the persisted reference and jumps to the re-entry point. A call initiating the asynchronous operation with references to the callback method and the persisted local variables is generated, as is a return of control from the current routine to the execution environment. Code to raise an exception if an error occurs may also be generated.

### Conclusion

An asynchronous complier generates asynchronous programming model (APM) code from straightforward source code. The asynchronous compiler hides the awkward complexity of APM from the programmer, allowing him or her to focus on the logical function of the application. Code implementing such functions may become more manageable.

The asynchronous compiler uses language constructs to mark methods as asynchronous. For every asynchronous method call the compiler generates a re-entry point right before the next operator and a call back for the generated re-entry point. The asynchronous compiler may also enable structured error handling (SEH) by directing error notifications to appropriate catch statements in try-except blocks.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A computer implemented method comprising:
receiving a program to be compiled;
identifying an asynchronous method call;
generating a re-entry point before a next operator;
generating a callback for the generated re-entry point; and
generating asynchronous programming model code.

2. The method of claim 1 and further comprising enabling structured error handling by directing error notifications to appropriate catch statements.

3. The method of claim 2 wherein the catch statements are in try-except blocks in the generated code.

4. The method of claim 1 and further comprising compiling the generated code.

5. A computer implemented method comprising:
receiving a program to be compiled;
identifying a sub-routine that invokes an asynchronous operation;
generating a re-entry point before a next operator following a call;
generating code to register the re-entry point as a notification method for the call with the execution environment;
generating the call initiating the asynchronous operation with reference to the notification method; and
generating a return of control from a current routine to the execution environment.

6. A computer implemented method, wherein a compiler automatically handles the complexity of an asynchronous programming model, the method comprising:
identifying sub-routines that invoke asynchronous operations;
when a call of such a sub-routine occurs in source code, the compiler:
generating a reentry point before the next operator that immediately follows call;
generating code to register the reentry point as a notification method for the call with the execution environment;
generating the call initiating the asynchronous operation with reference to the notification method; and
generating a return of control from current routine to the execution environment.

7. The method of claim 6 wherein an execution environment maintains local variables in memory.

8. The method of claim 6 and further comprising generating code to raise an exception to the execution environment if any errors occur.

9. The method of claim 6 wherein the compiler implements the result in complex source code that is then compiled.

10. A compiler implemented method, wherein the compiler automatically handles the complexity of an asynchronous programming model, the method comprising:
identifying sub-routines that invoke asynchronous operations;
when a call of such a sub-routine occurs in the source code, the compiler:
generating a reentry point before the next operator that immediately follows call;
generating code to persist the calling method's local variables;
generating a callback method that:
restores the local variables from the persisted reference;
jumps to the reentry point;
generating the call initiating the asynchronous operation with references to the callback method and the persisted local variables; and
generating a return of control from current routine to the execution environment.

11. The method of claim 10 wherein an execution environment realizes local variables as references to a processor execution stack.

12. The method of claim 10 wherein the callback method raises an exception if any errors occur.

13. The method of claim 10 wherein the compiler implements the result in complex source code that is then compiled.
